(19) United States
(12) Patent Application Publication
(10) Pub. No.: US 2026/0309864 A1
(43) Pub. Date: Oct. 8, 2026

(54) LINE SCANNING WITH DEEP LEARNING

(71) Applicant: THRUVISION LIMITED, Abingdon, Oxon (GB)

(72) Inventor: Nicholas Stuart GRAHAM-RACK, Surrey (GB)

(73) Assignee: THRUVISION LIMITED, Abingdon, Oxon (GB)

(21) Appl. No.: 19/482,217

(22) PCT Filed: May 7, 2024
(86) PCT No.: PCT/IB2024/054453

§ 371 Date: Nov. 6, 2025

Related U.S. Application Data
(60) Provisional application No. 63/500,751, filed on May 8, 2023.

(51) Int. Cl. G01S 13/88; G01S 13/42; G06V 10/40; G06V 10/764; G06V 10/82; G06V 20/52; G06V 40/10

(52) U.S. Cl. CPC G01S 13/886; G01S 13/426; G01S 13/887; G06V 10/40; G06V 10/764; G06V 10/82; G06V 20/52; G06V 40/10

(57) ABSTRACT

Methods and devices for computer-implemented scene processing include obtaining samples of a scene in a field of view based on output from one or more radio frequency (RF) detector arrays configured to receive radiation according to a scan pattern. The samples are processed through a plurality of one-dimensional convolution filters, and a three-dimensional feature tensor is generated based on the processing. Using a convolutional neural network, additional processing is used to detect one or more properties of the scene, and an output is generated indicating the detected one or more properties of the scene.

### TECHNICAL FIELD

This disclosure relates to imaging, and in particular, deep convolutional neural network processing of line-scan sensor outputs, including those in high-frequency applications.

### BACKGROUND

Deep convolutional neural networks (CNN) may process two-dimensional (“2-D”) images. For instance, after training and configuration, convolution filters in a first CNN layer typically detect low-level features in images, such as edges and blobs. The output of the first CNN layer represents an encoding of the low-level structure in the image, to be further processed by later layers. FIG. 1 illustrates an example of learned filters in a convolution layer, for instance, as part of low-level feature extraction in a convolutional neural network as provided in Krizhevsky et al., Imagenet Classifications with Deep Convolutional Neural Networks, Advances in Neural Information Processing (2012). Further, an edge detector can be used in image processing based on convolution filters or other linear or non-linear operations. For instance, a pair of 2-D convolution filters, with orthogonal kernels, can be used to detect a horizontal and vertical edge response separately. The output of these two filters can be combined to provide an orientation and strength response for any edge present at a location in an image. FIG. 2 illustrates examples of edge detecting convolution filters.

Some imaging can be based on detection of high-frequency signals. One example is provided in international patent publication number WO2021/074888, which describes a terahertz camera with multiple detector arrays.

There remains a need for improved processing of sensor outputs and image data, and in particular, with respect to high-frequency applications.

### SUMMARY

According to aspects of the present disclosure, a linear array sensor is used to image a scene. A deep Convolutional Neural Network (CNN) is then used to process the output of the sensor(s) in order to generate outputs that are dependent on the scene content.

According to one aspect, a computer-implemented scene processing method is provided. The method includes obtaining samples of a scene in a field of view based on output from one or more radio frequency (RF) detector arrays configured to receive radiation according to a scan pattern. In some embodiments, the method includes processing the samples through a plurality of one-dimensional convolution filters, or other linear or non-linear operations, and generating a multi-dimensional feature tensor, such as a three-dimensional feature tensor, based on the processing. The method further includes processing, using a convolutional neural network, the multi-dimensional feature tensor to detect one or more properties of the scene. The method includes generating an output indicating the detected one or more properties of the scene.

In another aspect, a computer-implemented scene processing method is provided. The method includes obtaining samples of a scene in a field of view based on output from one or more detectors according to an orthogonal scan pattern. The orthogonal scan pattern comprises a first line scan pattern oriented orthogonally to a second line scan pattern, a first set of one or more points along the first line scan pattern, and a second set of one or more points along the second line scan pattern, where the first set of one or more points and the second set of one or more points correspond to one or more locations of crossings of the first line scan pattern and the second line scan pattern. The method includes processing a first set of samples corresponding to the first line scan pattern and a second set of samples corresponding to the second line scan pattern through a plurality of one-dimensional convolution filters, or other linear or non-linear operations. The method can include extracting, based on the processing, a first three-dimensional feature tensor for the first set of samples and a second three-dimensional feature tensor for the second set of samples. The first three-dimensional feature tensor comprises a first number of vector values associated with a number of points in the first set of one or more points and the second three-dimensional feature tensor comprises a second number of vector values associated with a number of points in the second set of one or more points. In embodiments, the method includes concatenating the first three-dimensional feature tensor with the second three-dimensional feature based on the one or more locations of crossings of the first line scan pattern and the second line scan pattern, where the concatenating generates a third three-dimensional feature tensor. The method may further inclue processing, using a convolutional neural network, the third three-dimensional feature tensor to detect one or more properties of the scene in the field of view. The method can also generate an output comprising the detected one or more properties of the scene. In certain aspects, the detectors may comprise one or more RF detector arrays. While embodiments describe orthogonal scan patterns, one or more of the methods described herein can be implemented where scan directions are complementary, non-orthogonal directions. Additionally, while three-dimensional tensors are used as an example, other multi-dimensional tensors can be used in embodiments.

According to another aspect, a scene processing method is provided. The method includes generating a first set of samples corresponding to a first line scan pattern of a scene in a field of view by using one or more detector arrays to scan the scene along a first direction at a first angle offset from a principal axis of the one or more detector arrays. The method includes generating a second set of samples corresponding to a second line scan pattern of the scene in the field of view by using the one or more detector arrays to scan the scene along a second direction at a second angle offset from the principal axis, wherein the second direction is orthogonal to the first direction. The method includes combining the first set of samples and the second set of samples according to an orthogonal scan pattern of the scene in the field of view, where the orthogonal scan pattern comprises (i) the first line scan pattern oriented orthogonally to the second line scan pattern, and (ii) one or more points corresponding to one or more locations of crossings of the first line scan pattern and the second line scan pattern. The method includes processing the first set of samples and the second set of samples according to the orthogonal line scan pattern to detect one or more properties of the scene in the field of view. The method includes generating an output comprising the detected one or more properties of the scene. While embodiments describe orthogonal scan patterns, one or more of the methods described herein can be implemented where scan directions are complementary, non-orthogonal directions.

According to another aspect, a scene processing system is provided. The system includes a processor and a non-transitory memory coupled to the processor. The processor is configured to perform one or more of the methods described above.

According to yet another aspect, a computer program is provided. The computer program includes instructions which when executed by a processor causes the processor to perform steps of the methods described above.

In another aspect, a scene processing system is provided. The system includes one or more detector arrays, a processor, and a computer readable memory coupled to the processor, where the processor is configured to perform the methods described herein.

According to some embodiments, a system includes one or more detector arrays and a scanning element, such as a scanning mirror, and is configured to perform one or more of the methods described herein.

### BRIEF DESCRIPTION OF THE DRAWINGS

The accompanying drawings, which are incorporated herein and form part of the specification, illustrate various embodiments.

FIG. 1 illustrates an example of low-level feature extraction in a convolutional neural network.

FIG. 2 illustrates examples of edge detecting convolution filters.

FIG. 3 illustrates an example of a line-scan imaging system.

FIG. 4 illustrates potential sensor response offset drift in a line-scan imaging system.

FIG. 5 illustrates deep neural processing of line-scan data via an intermediate image stage, according to some embodiments.

FIG. 6 illustrates an orthogonal scan pattern, according to some embodiments.

FIG. 7 illustrates processing of a line scan, according to some embodiments.

FIG. 8 illustrates a processing approach, according to some embodiments.

FIGS. 9A and 9B illustrate aspects of an orthogonal scan pattern, according to some embodiments.

FIG. 10 illustrates a line scan of a field of view, according to some embodiments.

FIG. 11 illustrates an orthogonal line scan of a person in a field of view, according to some embodiments.

FIG. 12 illustrates driving an orthogonal scan pattern, according to some embodiments.

FIG. 13 illustrates driving an orthogonal scan pattern, according to some embodiments.

FIG. 14 illustrates edges in a scene for an orthogonal scan pattern as compared to a conventional scan pattern, according to some embodiments.

FIG. 15 illustrates a comparison of line spacing in an orthogonal scan and a conventional scan pattern, according to some embodiments.

FIG. 16 illustrates an effect of orthogonal scanning on an optical image, according to some embodiments.

FIG. 17 illustrates an effect of orthogonal scanning on a distorted optical image, according to some embodiments.

FIG. 18 illustrates ingestion of data obtained using an orthogonal scan pattern to a deep neural network, according to some embodiments.

FIG. 19 illustrates ingestion of data obtained using an orthogonal scan pattern to a deep neural network, according to some embodiments.

FIG. 20 illustrates ingestion of data obtained using an orthogonal scan pattern to a deep neural network, according to some embodiments.

FIG. 21 illustrates a 3-D tensor of features extracted from an orthogonal scan pattern, according to some embodiments.

FIG. 22 illustrates a method, according to some embodiments.

FIG. 23 illustrates a method, according to some embodiments.

FIG. 24 illustrates a method, according to some embodiments.

FIG. 25 is a block diagram of a computing system, according to some embodiments.

FIGS. 26A-26C illustrate aspects of a detection systems according to some embodiments.

FIG. 27 is a schematic illustrating a system according to some embodiments.

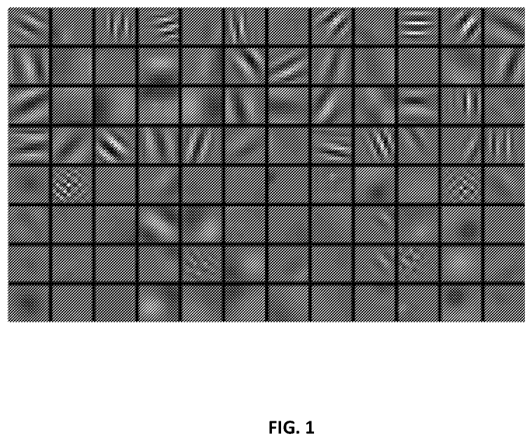

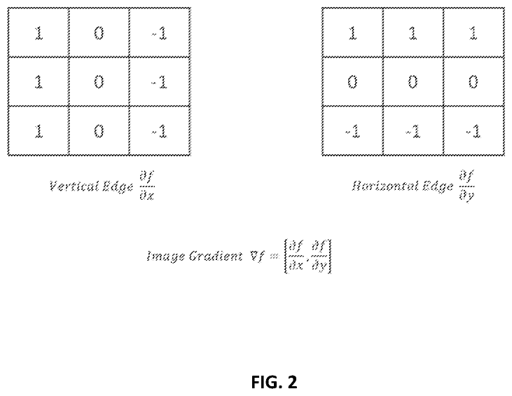

### DETAILED DESCRIPTION

Aspects of the present disclosure relate to processing of line scan data obtained from a high-frequency detection system using a deep CNN.

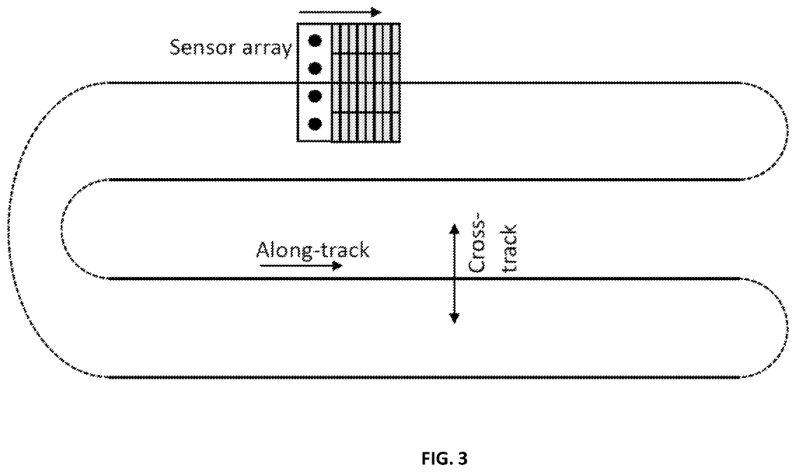

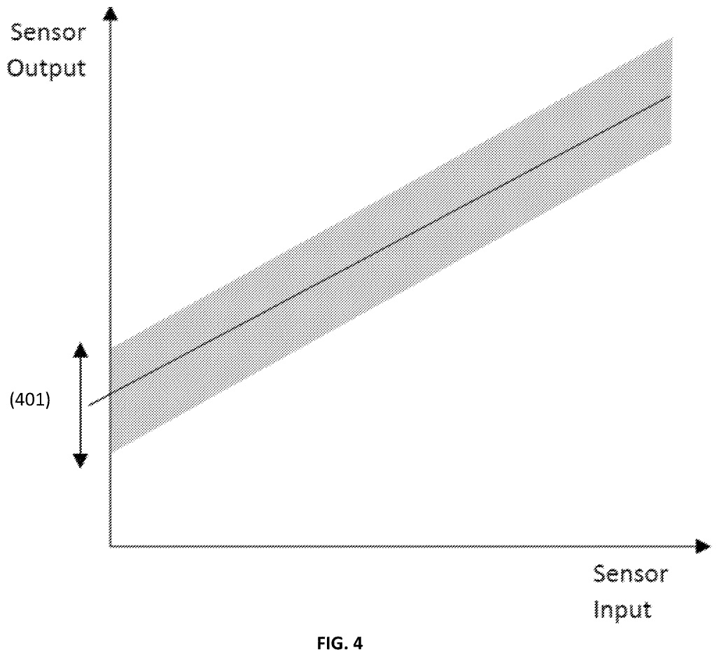

FIG. 3 illustrates an example of a line-scan imaging system. In this example, the line-scan imaging system forms a 2-D image by sweeping a linear array of sensors across a scene in a direction orthogonal to the primary axis of the array and the axis of the individual sensors. Each pixel value is obtained, for instance, by integrating the signal from a sensor (channel) in the array over a time period. The spatial resolution in a line-scan imaging system is typically different in the along-track and cross-track directions. Signal-to-noise ratio and line-speed, for example, govern the spatial resolution in the along-track direction. Array sensor spacing, for example, governs the spatial resolution in the cross-track direction. One potential problem in some line-scan imaging systems is that each sensor (channel) in the array may be subject to unpredictable drift over time in an additive offset term in its response to a given input. FIG. 4 illustrates sensor response offset drift, and in particular, a potential offset drift range 401.

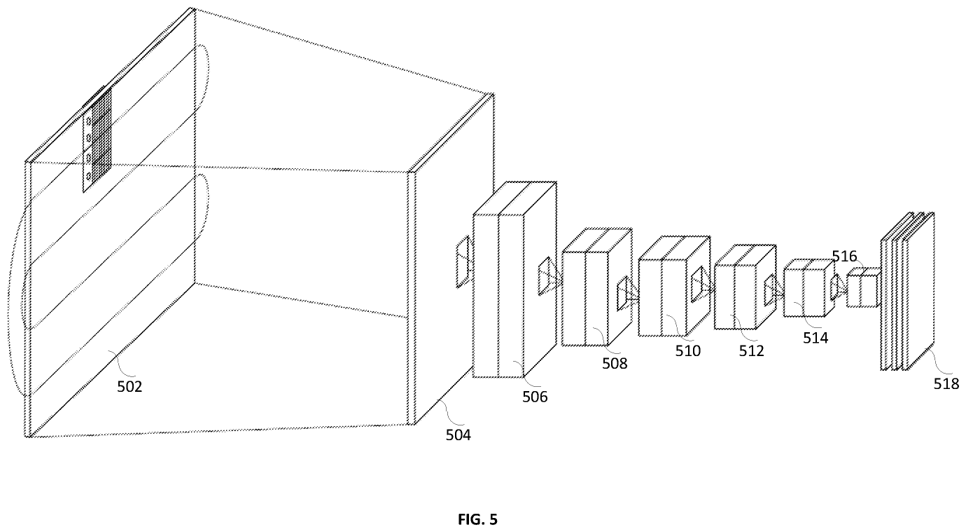

FIG. 5 illustrates deep neural processing of line-scan data via an intermediate image stage, according to some embodiments. In some embodiments, it may be desirable to process the output of a line-scan imaging system using a deep CNN. However, because deep CNNs typically process 2-D images, one approach is to first convert the output from the array sensors (channels) into a 2-D digital image. This might be achieved, for example, by allocating each line of data to a row of pixels in the image and then mapping blocks of samples along the line to each pixel in the row (e.g., by averaging samples in each block to make a pixel value). In so doing, it is possible that information in the original line-scan data is lost before the image is presented to the CNN. However, the resulting image can nevertheless be presented to the CNN, which can then handle it as it might any other 2-D image. With reference to FIG. 5, the leftmost component 502 can represent the process of line-scanning a scene to obtain line-scan data. The element 504 can represent a 2-D digital image, and the lines between their corners can indicate the process described above, whereby the line scan data is converted to the image. The remaining elements 506-518 are a representation of the layers of an example a CNN.

According to other embodiments, rather than convert the sensor array output to a 2-D image and then subject that image to 2-D convolutions in the early layers of the CNN, a different approach may be used.

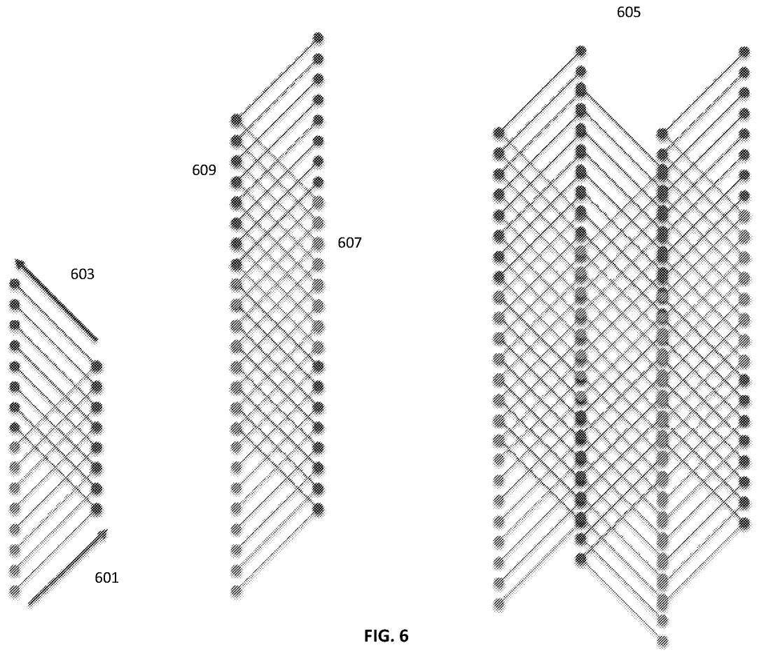

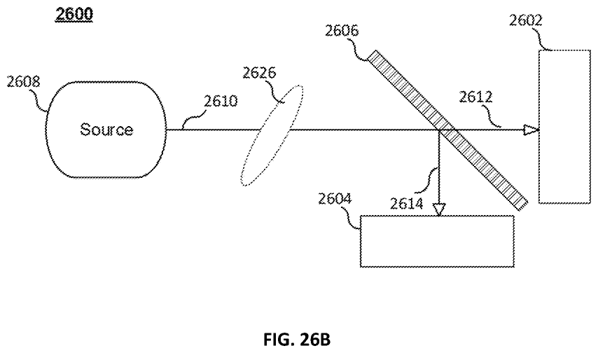

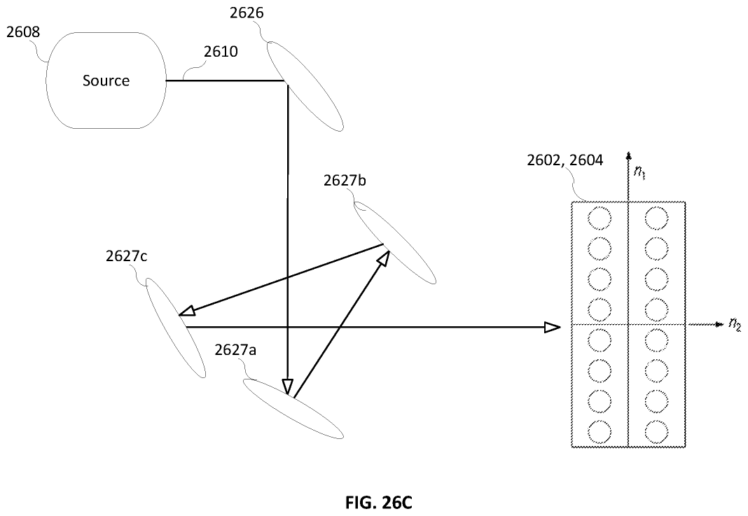

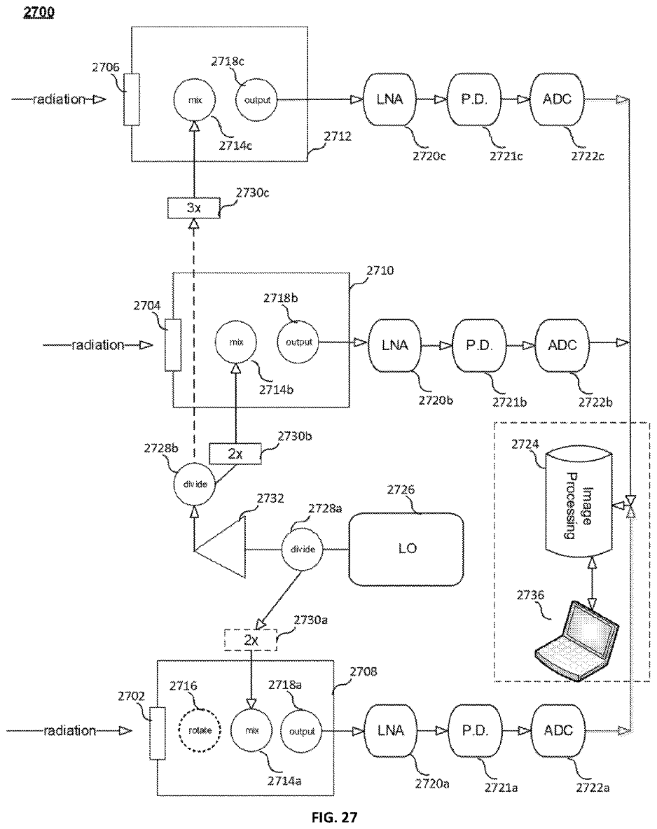

FIG. 6 illustrates an orthogonal scan pattern, according to some embodiments. In some embodiments, a different scan pattern—an orthogonal scan pattern—is used, which results in each scene element being scanned in orthogonal directions or near-orthogonal directions by the sensor array, in quick succession. This may be accomplished, for example, using a scanning element as described with respect to FIGS. 26A-26C and FIG. 27. While “orthogonal” scanning is used as an example, embodiments are applicable to arrangements where the scan directions are different but not necessarily truly orthogonal. This can include embodiments where the scanning is performed in complementary directions, and thus, able to deliver some or most of the benefits of truly orthogonal directions. As shown in FIG. 6, at 601 a sensor array containing eight sensors or detectors scans a field of view in a first direction (towards the right in this illustration) at an angle offset from a principal axis of the sensor array (approximately 45 degrees from the horizontal axis). At 603, the sensor array then scans a field of view in a second direction orthogonal to the first direction (towards the left) at an angle offset from the principal axis of the sensor array (approximately 45 degrees from the horizontal axis). The orthogonal crisscross scanning repeats at 607 and 609. The entire scan may be repeated again, as necessary, in order to generate line scan 605 of an entire field of view. In embodiments, this is an orthogonal line scan. While a single array using eight sensors or detectors is used in this example, other number of arrays and sensors or detectors may be used in embodiments to generate a line scan. As part of a scanning processes, in-bound radiation from the scene is collected and selectively steered and focussed onto a stationary sensor, according to embodiments.

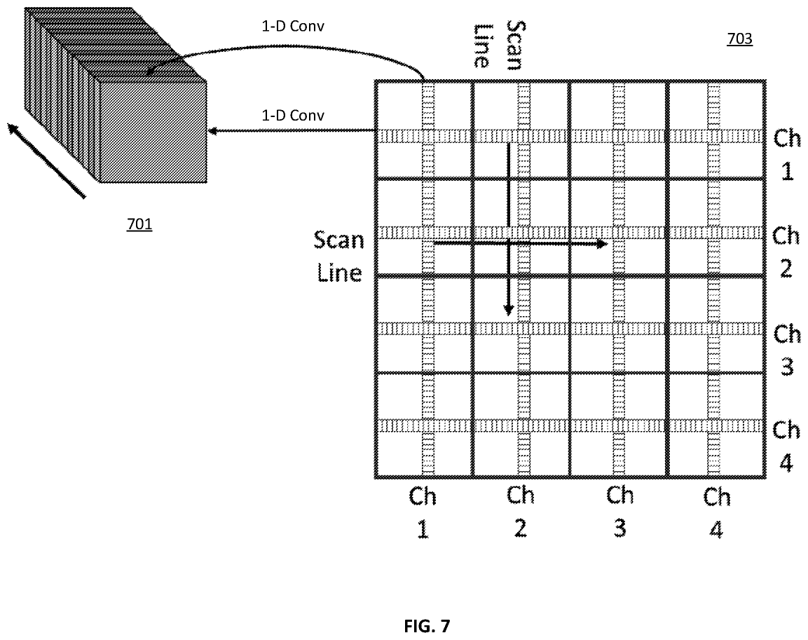

FIG. 7 illustrates processing of a line scan, according to some embodiments. At 701, in some embodiments, the output (e.g., samples, or encodings of scene elements) of each array sensor (channel) is processed through a set of several one-dimensional (1-D) convolution filters, each with different kernels, to obtain an encoding of the low-level features (edges) in the scene as viewed along the one-dimensional path of that sensor (channel). In certain aspects, multiple1-D convolution filters each generate a pair of outputs at a given grid point. At 703, at each point of intersection, corresponding to a scene element, the 1-D feature encoding obtained from one of the passes is concatenated with the 1-D feature encoding obtained from the pass in the orthogonal direction to produce a combined feature encoding for that scene element. Each of the scene element encodings may be encoded into a 3-D tensor in which the first two dimensions correspond to the spatial dimensions of the scene and the third dimension holds the feature encodings. While 3-D tensors are used as an example in embodiments, other multi-dimensional tensors may be used, including tensors with higher-order information. In embodiments, the 3-D tensor may be presented to a CNN. In certain aspects, this tensor may be similar in content and structure to that which might normally be found passing from the first layer of a CNN to the next when that CNN is processing a 2-D image. While convolutional filters are used in this example, according to embodiments, other linear or non-linear operations may be used. According to embodiments, a system having one or more detector arrays can be used. One example is provided in connection with FIGS. 26A-26C and FIG. 27.

There may be several benefits to the foregoing approach.

Isotropic Spatial Resolution. Whilst the size of each scene element is determined by sensor spacing in the array (e.g., linear array), the low-level features within that element can be encoded at the along-track resolution of the system. Since those features are sampled in two orthogonal directions, the spatial resolution of the system is now isotropic. According to embodiments, imaging system arrangements provided below can be used. By contrast, in a line scan image such as shown in connection with FIG. 3, the across-track resolution may be appreciably poorer than that along-track.

Automatic Compensation for Sensor Offset. Low-level feature extraction for each scene element, in one or other of the two orthogonal directions, may be performed by a single sensor over a very short time interval during which it is reasonable to assume that the offset term associated with that sensor's response is constant. Since edge-detecting convolution kernels can be chosen to have zero-sum elements, the absolute magnitude of the offset term does not affect the output. Compare this with an edge detection performed in the across-track direction of a conventional line scan image where failure to accurately compensate for different (drifting) offsets in adjacent sensors (channels) will generally resulting in corruption of the edge features.

Improved Motion Resilience. Low-level feature extraction for each scene element is performed over the (short) time taken to make the consecutive pair of orthogonal passes over the element. The effect of scene object motion on low-level feature extraction is limited by this time interval. Compare this with low-level feature extraction performed on a region covered by two interleaved line scan swathes in a conventional line scan image. Here the corresponding time interval is the generally longer time taken for the line-scan to complete the first swathe and then return on the second, allowing greater opportunity for motion-induced distortion before low-level features are extracted.

An additional benefit is that 1-D-convolutions are computationally less demanding than 2-D convolutions and have fewer parameters to be set or learned. This reduces the complexity and computational demands compared to the traditional approach of converting the array output to a 2-D image which is then subjected to 2-D convolutions in the first layer of a CNN.

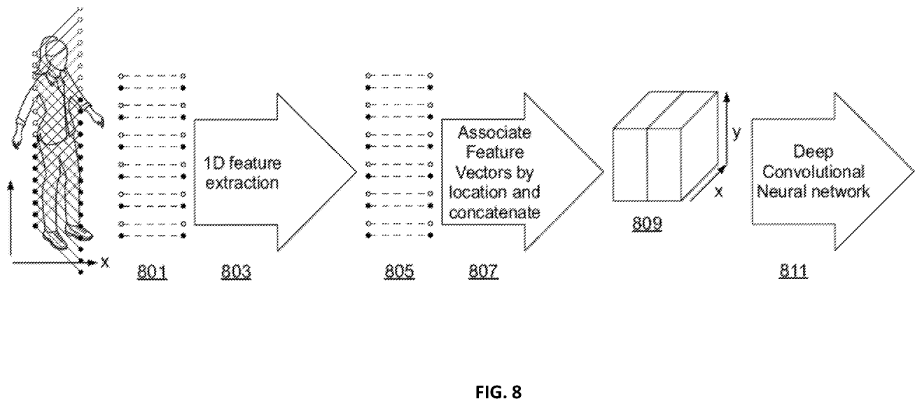

FIG. 8 illustrates a processing approach, according to some embodiments. At 801, scan line samples are captured along with location metadata. At 803, each line sample is processed using a series of 1-D convolutions. At 805, 2-D low-level feature tensors are extracted for each line sample based on the 1-D convolutions, where each tensor includes line scan features and location metadata. At 807, the 2-D feature tensors are associated by location and concatenated to generate a 3-D tensor shown at 809, which may be a low level feature tensor according to embodiments. At 811, the 3-D tensor is processed using a CNN.

Certain aspects of the geometry of an orthogonal scan pattern, according to some embodiments, are further described below.

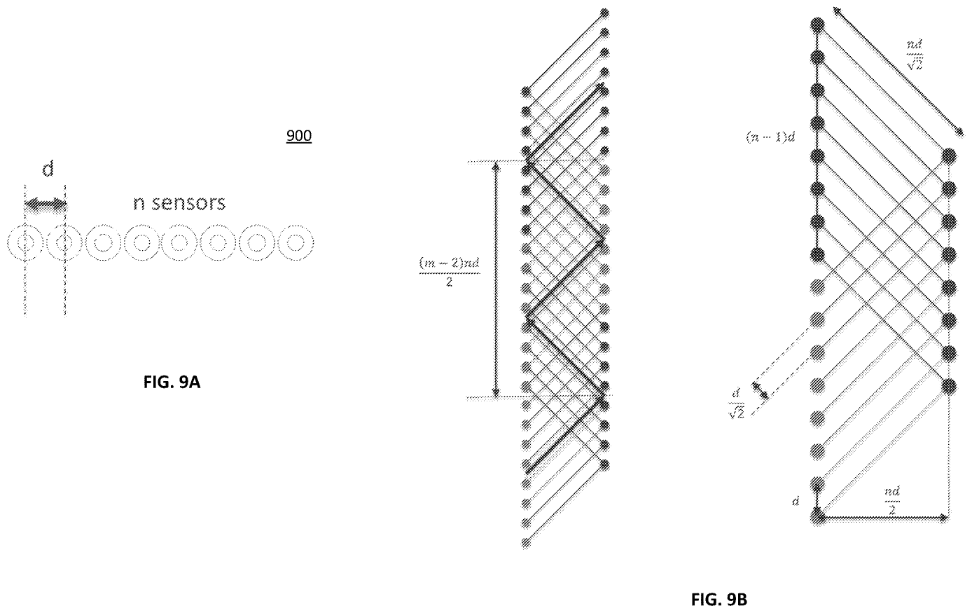

FIGS. 9A and 9B illustrate aspects of an orthogonal scan pattern, according to some embodiments. Referring now to FIG. 9A, an array 900 of n sensors made from 4-sensor blocks is provided; however, other numbers of sensors and different blocks sizes may be used. As illustrated with respect to FIG. 9B, the sensor array is swept alternatively in two orthogonal directions, both at 45° from a principal axis of the sensor array, to generate the grid pattern shown. According to some embodiments, an array of n sensors with spacing d, making m sweeps delivers a swath of useable dimensions:

$$\frac{( m - 2 ) nd}{2}$$

high by nd/2 wide containing a grid with spacing

$$\frac{d}{\sqrt{2}}$$

with each sweep being

$$\frac{nd}{\sqrt{2}}$$

long. Although 45% is provided as an example, other complementary angles may be used in some embodiments.

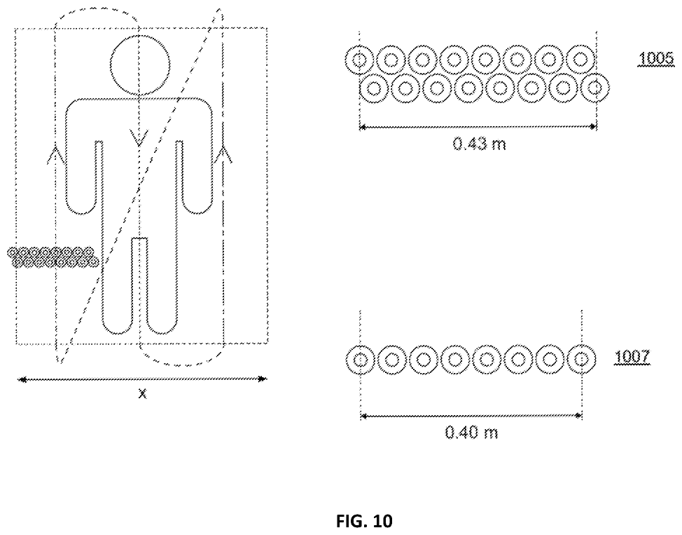

FIG. 10 illustrates a line scan of a field of view, according to some embodiments. In some embodiments, a multi-sensor array in a 3-line pattern generates a field of view X meters wide. For instance, a 16-channel sensor array in a 3-line pattern can generate a field of view 1.3 meters wide at an object plane 3.5 meters in front of a camera. While 1.3 m@3.5 m is used as an example, other dimensions can be used, including based on different array sizes and patterns. In the example of FIG. 10, a first sensor array 1005 has 16-channels with a spacing of 0.03 m (3 cm) at 3.5 meters, and the first sensor array projects to a width of 1.3/3=0.43 m at 3.5 m. A second sensor array 1007 has 8-channels formed from two 4-channel blocks stacked end-on-end. The sensor spacing in the second sensor array is 0.06 m (6 cm) at 3.5 m and will project to a width of 0.40 m at 3.5 m. Again, these spacings are provided as examples, and different spacings (and numbers of sensors) can be used.

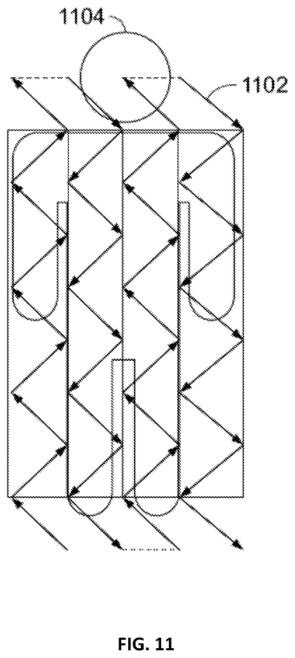

FIG. 11 illustrates an orthogonal line 1102 scan of a person in a field of view, according to some embodiments. A person (or other object or element, i.e., a “scene element”) 1104 may be located 3.5 m in front of a camera, as an example. Optical body segmentation may be used to locate and isolate the person, in which case only a tight scan needs to be performed from the person's neck to ankle. Based on the configuration shown in FIG. 10 of an array of 8 sensors with spacing 0.06, making m sweeps delivers a swathe of useable dimensions: 0.24(m−2) high by 0.24 wide containing a grid with spacing 0.04 m with each sweep being 0.34 long. Thus 4 swathes of 9 sweeps each would cover a typical person ankle to neck (1.7 m high by 1.0 m wide), with a total of 36 sweeps. Again, other distances, sizes, and spacings may be used in embodiments.

Certain aspects of the dynamics of an orthogonal scan pattern, according to some embodiments, are described further below.

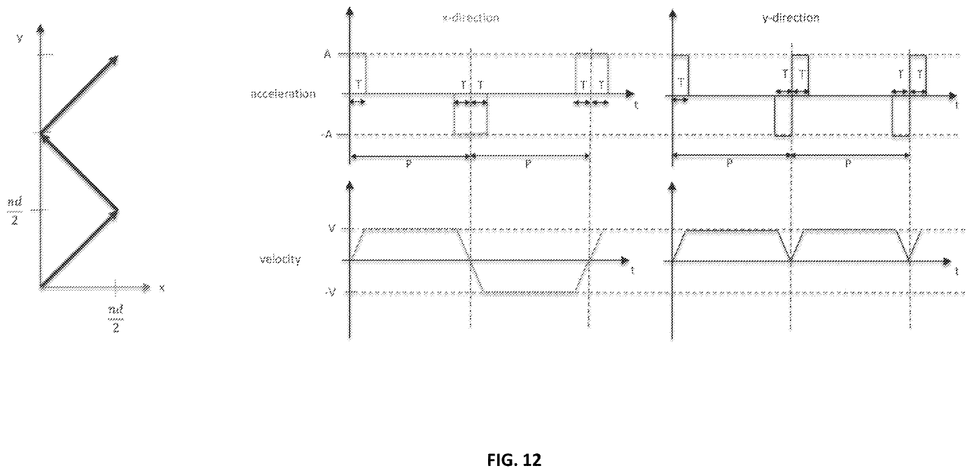

FIG. 12 illustrates driving an orthogonal scan pattern, according to some embodiments. In this example, an n-channel linear sensor array is de-projected into the object plane at a distance in front of the camera. FIG. 12 illustrates the dynamics of this projected point in space, which may be delivered, for example, by an appropriate sequence of angular displacements of a mirror. The mirror may be, for instance, part of a system as described with respect to FIGS. 26A-26C and FIG. 27. To achieve the required scan pattern, the de-projected position of the sensor array in the object plane is driven in the x- and y-directions with the acceleration and velocity profiles shown in FIG. 12. The pattern is generated by the same basic profile, repeated, with alternating sign reversal in the x-direction.

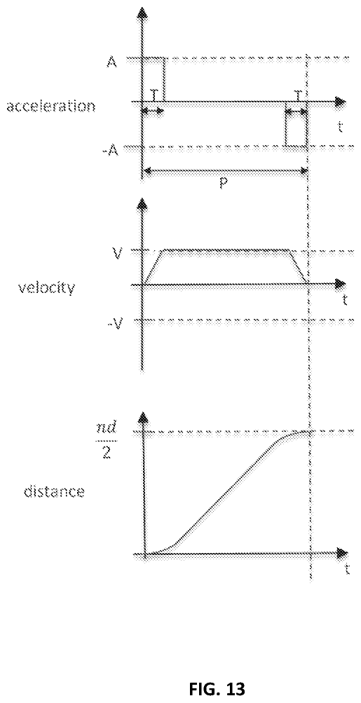

FIG. 13 illustrates driving an orthogonal scan pattern, according to some embodiments. The required distance (length of each sweep) may be fixed by the sensor geometry, but the following parameter values may be chosen to achieve the orthogonal scan pattern:
Acceleration, A (ms⁻²)
Acceleration interval, T(s)
   These two values will result in a peak velocity V(ms⁻¹) and a period P(s), and one can choose to define duty ratio r=T/P.

The system is constrained as follows:

$$distance = \frac{nd}{2} = V ( P - T ) = A T ( P - T ) = A P r ( P - P r ) = A {P}^{2} r ( 1 - r )$$

### Accordingly:

$$P = \sqrt{\frac{nd}{2 r ( 1 - r ) A}} \qquad ( 1 )$$

$$V = \sqrt{\frac{ndrA}{2 ( 1 - r )}} \qquad ( 2 )$$

$$\frac{V}{P} = r A \qquad ( 3 )$$

$$PV = \frac{nd}{2 ( 1 - r )} \qquad ( 4 )$$

$$0 \leq r \leq 0.5 \qquad ( 5 )$$

According to some embodiments, for overall performance it may be desirable to minimize the Period P (e.g., scan someone faster) and minimize the sweep speed V (more samples per unit line length may increase signal-to-noise). Equation (4) shows that for a given sensor geometry (n and d), P and V may be minimized together by having the duty ratio r as close to zero as possible, such that in the limit

$$P V = \frac{nd}{2} .$$

One must then trade P and V directly (high-speed/short-period, low-speed/high-period, as expected). Equation (3) shows that for a given choice of P and V one must trade r and A directly (short acceleration phase requires higher acceleration and vice-versa). As r approaches zero A tends to infinity. So, the physical limits on acceleration A constrain the lower limit on r, which in turn constrains the product PV for a given sensor geometry.

As shown in Tables 1-3 below, in some embodiments it may be possible to scan a person in a field of view in approximately 1 second, with a peak line-speed of approximately 10 m/s. Specific values are provided as examples. According to some embodiments, the values for Acceleration A in the tables below represent estimates for physical limits for a particular system.

TABLE 1
Period P (s)

Acceleration A (m/s/s)

| Duty Ratio r | 2500 | 4900 |
|---|---|---|
| 0.05 | 0.045 | 0.032 |
| 0.1 | 0.033 | 0.023 |
| 0.2 | 0.024 | 0.017 |
| 0.4 | 0.020 | 0.014 |

TABLE 2
Peak Velocity V (m/s)

Acceleration A (m/s/s)

| Duty Ratio r | 2500 | 4900 |
|---|---|---|
| 0.05 | 6 | 8 |
| 0.1 | 8 | 11 |
| 0.2 | 12 | 17 |
| 0.4 | 20 | 28 |

TABLE 3
Typical Time to Scan Person (s)

Acceleration A (m/s/s)

| Duty Ratio r | 2500 | 4900 |
|---|---|---|
| 0.05 | 1.6 | 1.2 |
| 0.1 | 1.2 | 0.8 |
| 0.2 | 0.9 | 0.6 |
| 0.4 | 0.7 | 0.5 |

The following provides comparisons of examples.

According to some embodiments, one goal is to detect concealed objects by processing the line-scan samples using a deep convolutional neural network. Such a network will extract 2-D spatial features in a hierarchy, starting with low-level features such as edges.

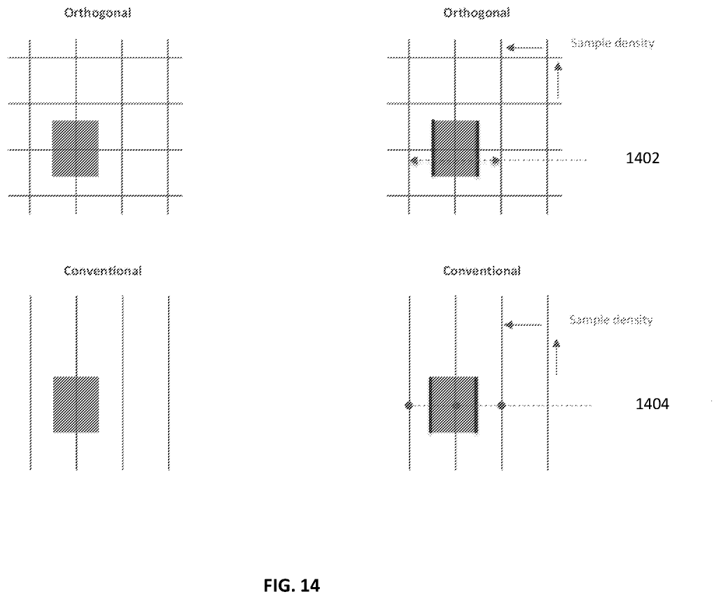

FIG. 14 illustrates edges in a scene for an orthogonal scan pattern as compared to a conventional scan pattern, according to some embodiments. In some embodiments, raw RF data is provided from which the low level 2-D spatial features present in the scene can be extracted as accurately as possible. In the example of FIG. 14, the orthogonal scan pattern can include 100s of samples 1402 in the region, whereas the conventional scan pattern has only three datapoints 1404 in the identified region.

In some embodiments, a convolution filter is used to find edges in the scene by processing the line scan samples, even when those samples are subject to low pass filtering and additive noise inherent in the sensor system. A measure of the quality of information contained in the raw scan sample data is the accuracy with which the position of edges of objects in the scene can be estimated. In some embodiments, a position of an edge of an object in a scene was predicted with an accuracy of approximately 1 cm according to the parameters shown in Table 4 below.

TABLE 4

| Parameter | Type | Nominal Value |
|---|---|---|
| Object Temperature | Scene | 5 |
| Contrast (DegC.) | | |
| Object Width (cm) | Scene | 3 |
| Sample Noise (DegC.) | System | 1.6 |
| Spot Size (cm) | System | 1.5 |
| Sample Density | System | 50 |
| (samples/cm) | | |

Other values may be used.

In some embodiments, convolutional filters may only detect edges (or the component of an edge) that are at a right angle to the line scan direction. In the case of the orthogonal scan pattern shown in FIG. 14, the data contains information about both horizontal and vertical edge features in the scene, at equal precision. In the case of the conventional scan pattern (in the orientation illustrated in FIG. 14), the data contains plenty of information about horizontal edges in the scene but much less information about vertical edges. In the conventional scan pattern, this issue may mitigated in two ways: (1) reduced sensor spacing (increasing channel count for a given sensor array width), and (2) interleaving. Using a 16-channel sensor in place of an 8-channel sensor may halve the line spacing between sensors, but at the expense of doubling the hardware. Additionally, running an 8-channel linear sensor in an interleaved pattern halves the line spacing, but at the expense of needing to double the line speed to cover the same area in the same time.

With conventional scan patterns, there may be a few limitations, including (1) data sparsity, (2) edge extraction, and (3) motion tear when interleaving.

Data sparsity: With the orthogonal scan, there may be hundreds of samples crossing the region shown at right angles to the two vertical edges, which can then be extracted using convolution filters. As described above, for typical system parameters and a sample density of 50 samples/cm, it is possible to achieve an accuracy in estimating edge position of ~1 cm with the orthogonal scan pattern. With the conventional scan, edge features must be extracted by comparing values obtained only on the three lines that straddle the region of interest as shown in FIG. 14. Samples may be averaged locally along each line to reduce the noise in the values used.

Channel offset drift: In the conventional scan pattern, the three data points from which one must estimate the edge size and strength may be produced by different receiver channels. Since each channel's response function may be subject to un-predictable offset drift, the differences must somehow be estimated and corrected for. Any residual error in the offset correction will affect the accuracy of edge estimation. By contrast, in the orthogonal scan pattern the samples used to extract the edge feature are all generated by the same channel over a very short interval during which any drift may assumed to be negligible. If the edge-detecting convolution kernel has zero-sum weights, the offset will just cancel out. Moreover, each crossing point in the orthogonal scan pattern grid provides a reference where two channels over-fly the same scene content, providing an excellent basis for continually re-estimating their relative offset.

Motion Tear when interleaving: If, in the conventional scan pattern example illustrated in FIG. 14, the middle of the three data points is from an interleave line-scan, then the middle data point will have been generated later than the two on either side, more so towards one end of the scan line. Any small movement of the target edge during that interval will induce an error in the edge feature extraction. By contrast, in the orthogonal scan all the samples from which a given edge is extracted are obtained in the time it takes to overfly that edge.

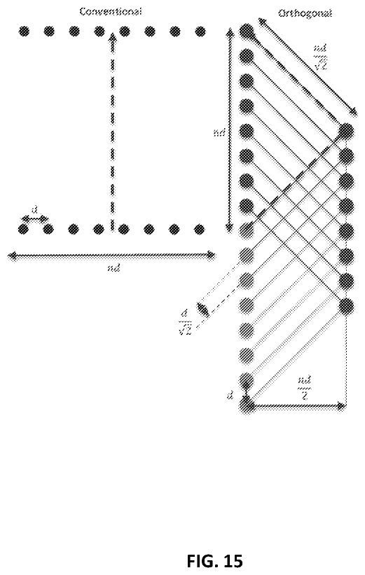

FIG. 15 illustrates a comparison of line spacing in an orthogonal scan and a conventional scan pattern, according to some embodiments. As shown in FIG. 15, an orthogonal scan pattern may deliver a swathe of half the width of the same sensor array in a conventional scan pattern. Additionally, the zigzag path may require the sensor array to travel \sqrt{2} times as far to cover the same swathe length. To cover the same swathe area, the orthogonal scan may need to cover 2\sqrt{2} times the distance of the conventional scan. So, to scan an area in the same time, assuming constant speed, the orthogonal scan pattern must have a line speed which is 2\sqrt{2} times that of the conventional scan pattern. For a given sample rate this means that the sample density (samples per unit length of scan line) in the orthogonal scan will be 2\sqrt{2} times lower than in the conventional scan.

The table below compares performance of an orthogonal scan pattern with four configurations using a conventional scan pattern.

TABLE 5

| | | Conventional Scan Pattern | | | |
|---|---|---|---|---|---|
| | Orthogonal | 8-channel sensor array | | 16-channel sensor array | |
| | Scan Pattern | Standard | Interleaved | Standard | Interleaved |
| Line spacing | 4 | 6 | 3 | 3 | 1.5 |
| (cm) | | | | | |
| Sample | 50 | 140 | 70 | 140 | 70 |
| Density | | | | | |
| Direction A | | | | | |
| (samples/cm) | | | | | |
| Sample | 50 | Not directly comparable | | | |
| Density | | | | | |
| Direction B | | | | | |
| (samples/cm) | | | | | |
| Edge Position | ~1 | ~6 | ~3 | ~3 | ~1.5 |
| Error | | | | | |
| Detection B | | | | | |
| (cm) | | | | | |
| Relative | 1 | 1 | 1 | 2 | 2 |
| Receiver Cost | | | | | |
| Channel Drift | Yes | No | No | No | No |
| Immunity | | | | | |
| Motion Tear | High | High | Low | High | Low |
| Resilience | | | | | |

The values were derived at a distance 3.5 m in front of the camera, the line speed for the orthogonal scan was 10 m/s, and all scans covered the same area in the same time interval. In almost all the metrics, the conventional scan patterns perform either comparably or worse than the orthogonal scan pattern. To achieve the orthogonal scan pattern, it was necessary to trade down in sample density from 140/cm to 50/cm in direction A when compared with the standard pattern.

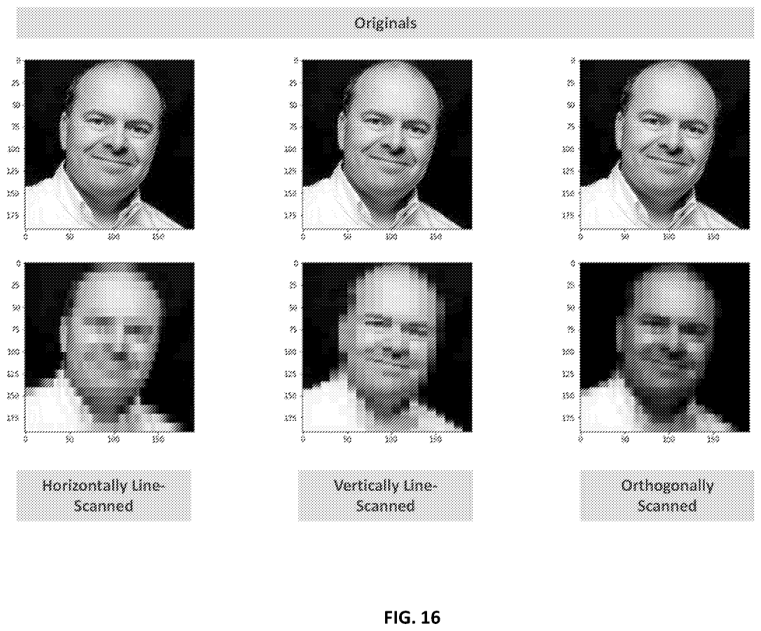

FIG. 16 illustrates an effect of orthogonal scanning on an optical image, according to some embodiments. FIG. 16 illustrates an orthogonal image that was separately line-scanned along the horizontal and vertical axis. The horizontal and vertical line-scans emphasize horizontal and vertical features, respectively. By combining the horizontal and vertical line-scans (e.g., using element-wise multiplication) to generate an orthogonally scanned version, there is improved structure around the eyes, nose and mouth, and the outline of the face.

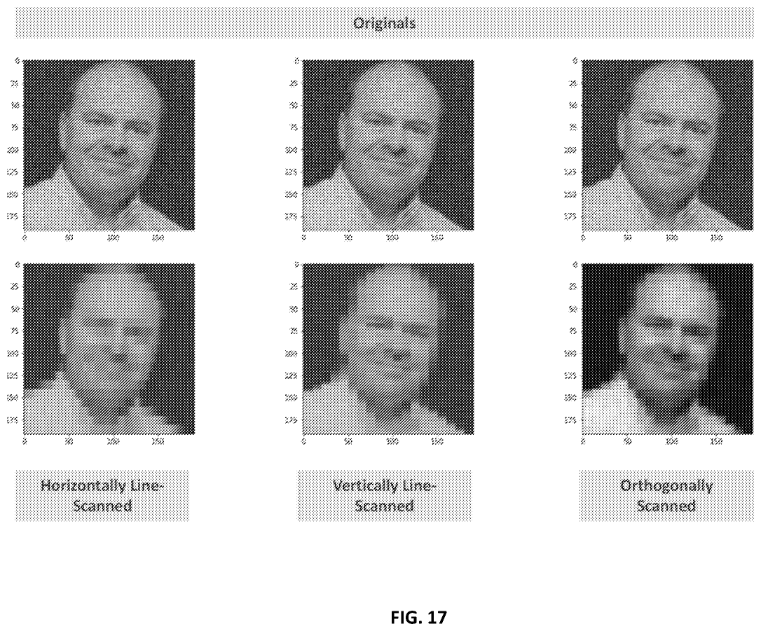

FIG. 17 illustrates an effect of orthogonal scanning on a distorted optical image, according to some embodiments. The original image shown in FIG. 16 has been blurred and noise has been added to better simulate sensor data from a high-frequency detection system. The same processes as described for FIG. 16 were performed to demonstrate a comparison of the feature detection between the horizontally and vertically line scanned images and the orthogonally scanned image.

Accordingly, the orthogonal line scanning techniques may offer improvements in image capture, image segmentation, image processing, and image classification applications, for example.

In some embodiments, an 8-channel linear sensor array (e.g., made from two standard 4-channel blocks) making m diagonal sweeps delivers a swath of useable dimensions 0.24(m−2) meters high by 0.24 meters wide, containing a grid with spacing 0.04 meters in all dimensions. A 36-sweep pattern may be sufficient to perform a tight orthogonal scan of a person at a distance of 3.5 meters. The system may deliver the acceleration required to scan a person at 3.5 m range with the orthogonal grid pattern in approximately 1 second, with a peak line speed of approximately 10 m/s. At such line speeds, according to some embodiments, the 8-channel orthogonal line scan pattern out-performs a conventional 16-channel scan pattern by offering similar spatial resolution on two axes to that otherwise achieved in only one axis. Moreover, halving the channel count may reduce the cost of the receiver. Other values may be used according to some embodiments.

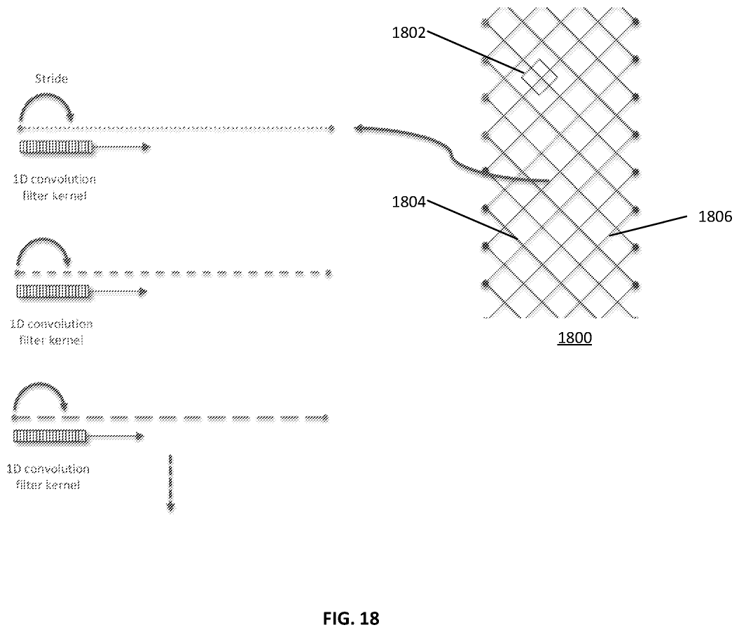

FIG. 18 illustrates ingestion of an orthogonal scan pattern to a deep neural network, according to some embodiments. The orthogonal scanning delivers lines of samples in the grid pattern 1800 shown in FIG. 18. Each grid element may be sampled by approximately 102 samples in each direction in this example. Each single scan line segment (illustrated by the box 1802 in grid pattern 1800) may contain approximately 103 samples. A sequence of 1D convolutions are applied to each line scan sample with an appropriate choice of padding and stride, and the features encountered along the line are encoded into a progressively smaller number of values. These values are still spaced along the line and maintain a spatial association. This process is continued until there are as many values as there are grid crossing points for the line, in some embodiments. Then, each value is associated with a grid crossing point. The filter kernel size, stride and padding may be different at each stage but are fixed by design, as are the number of stages. Additionally, the filter kernel weights at each stage are learnable.

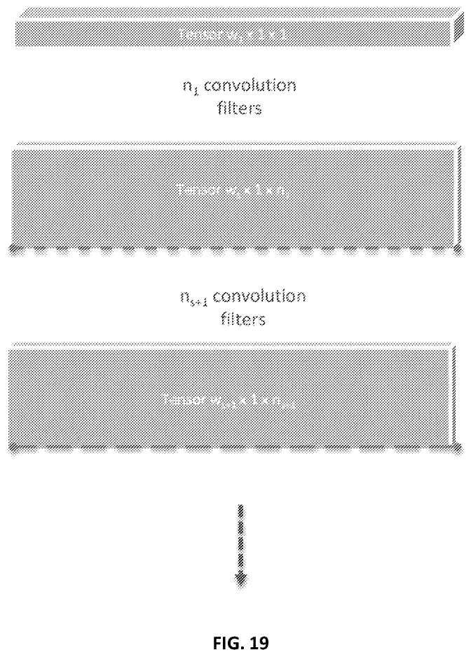

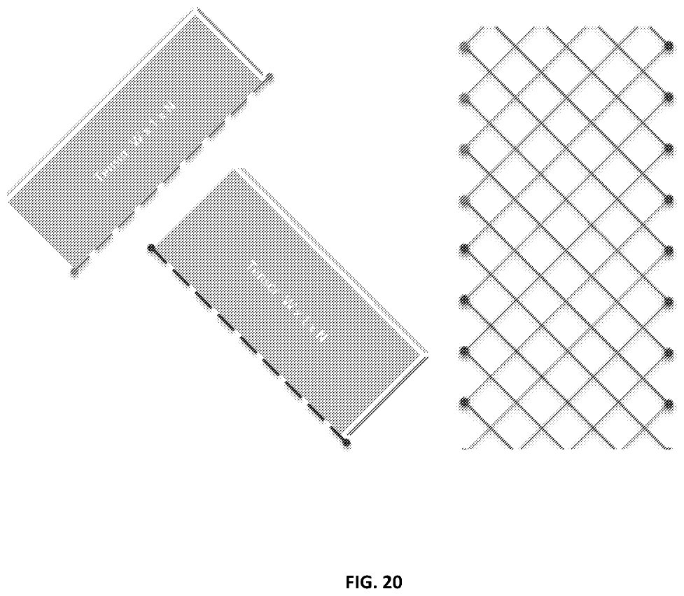

FIG. 19 illustrates ingestion of an orthogonal scan pattern to a deep neural network, according to some embodiments. As shown in FIG. 19, rather than a single 1-D convolution filter at each stage, multiple filters n may be applied at stage s (nₛ). The output of each stage is a tensor wₛ wide by 1 high by nₛ deep. Each filter operates independently on the full tensor from the previous stage and has dimensions accordingly. The width of the tensor output is controlled at each stage by controlling the filter dimensions, stride and padding at each stage. According to this process, one of the tensor (and filter) dimensions is reduced to one.

FIG. 20 illustrates ingestion of an orthogonal scan pattern to a deep neural network, according to some embodiments. As shown in FIG. 20, the final stage of the sequence shown in FIG. 19 is a generated tensor W wide by 1 high by N deep. The width W is equal to the number of crossing point nodes along each scan line (9 as shown in FIG. 20). At each of these spaced positions along the scan line, there is an N dimensional vector which encodes the feature content derived from the samples in that scan line in that local region, and there is the same thing for each of the orthogonal scan lines. Accordingly, at each crossing point (grid point) the appropriate two N-dimensional vectors are concatenated to form a 2N dimensional vector that encodes the local features in that location, with the benefit of both scan directions.

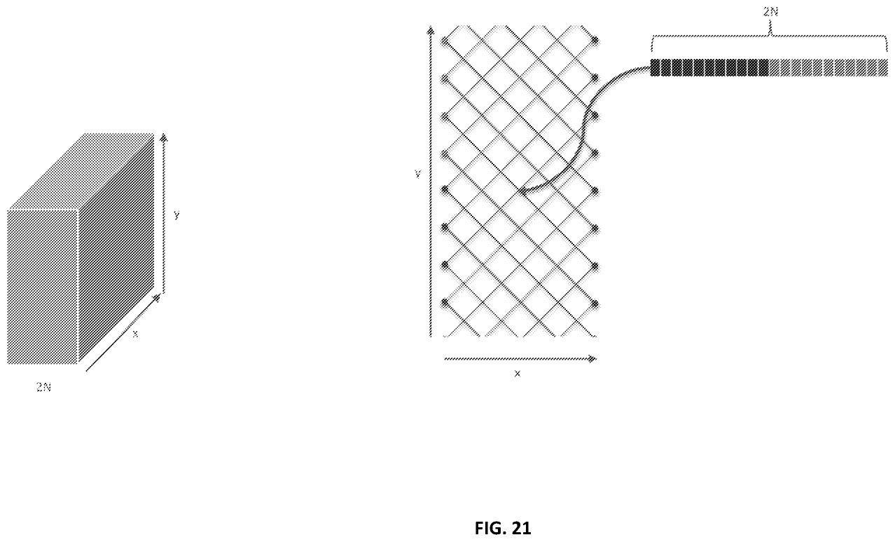

FIG. 21 illustrates a 3-D tensor of an orthogonal scan pattern, according to some embodiments. As shown in FIG. 21, there is a grid with a feature vector at each grid point that, according to some embodiments, is held as a tensor. Two of the dimensions of the tensor are the spatial dimensions of the scene, and the third is the feature vector. The 3-D tensor may be considered similar to those typically found a few layers into deep convolutional neural network processing a 2-D image, with the earlier processing stages replaced with the procedures shown and described in FIGS. 18-20.

According to some embodiments, FIG. 18 shows how the scene is sampled 1800 by a set of line-scans. In this example, each line contains the samples generated by a single channel (detector) in the sensor array. The lines 1804 are generated with the sensor array travelling in one direction, and the lines 1806 when it is travelling in the orthogonal direction. While embodiments may reference sensors swept across a scene or use similar terminology, in-bound radiation from the scene can be selectively steered and focussed onto one or more stationary sensors to give the effect of a travelling/moving sensor array.

In certain aspects, in an initial step, one can process each line of data individually, but apply the same process to each. That process can involve applying a succession of convolution operations to the line of data as illustrated in FIG. 18. At each stage, a kernel (whose values can be learned through a training process) is convolved with the output of the previous stage. Between each convolution stage, there could be additional non-linear linear and linear operations, though not illustrated. According to embodiments, the stages can be configured in such a way that at each stage the number of data elements in the output gets progressively smaller. For example, one might start with 1000 samples along one of the lines, and may end up with only 10. And if there was just a single convolution kernel (filter) at each stage, the output would be a tensor of width W (which progressively reduces), height 1 (because this a 1D line not a 2D image) and depth 1 (because there is just 1 convolution kernel (filter). But in fact, there may be several (n) convolution kernels at each stage. In this example, each filter generates an output tensor of dimensions W×1×1, but these are then stacked to make a tensor of dimensions W×1×n. Now at the next stage, there is a new set of (m) convolution kernels or filters. Each acts on the W×1×n input tensor and generates a W×1×1 output tensor, and these are then stacked to make a new W×1×m output tensor. And it can be arranged that the number of kernels (filters) at each stage increases, so the output tensor gets narrower and deeper. According to embodiments, at some point (e.g., after several stages) the tensor has reached the dimensions W×1×N and is arranged such that W is the number crossing points on each line (e.g., as illustrated in 1800). In certain aspects, each crossing point can be associated with a 1×N tensor (e.g., a vector) contributed by the 1806 scan line, and another 1×N vector contributed by the 1804 scan line. Each vector is encoding some content in the region of that crossing point. These can be concatenated to make a 2N vector, which encodes the content in the region of that crossing point.

In this respect, the grid of crossing points can be an image in which each crossing point is a pixel, and each pixel contains a 2N vector that contains the content for that pixel. In certain aspects, this may be analogous to a colour image in which each pixel has Red, Green and Blue Channels. In certain aspects it can be considered as a tensor of dimensions A×B×2N, where A and B are the number of crossing points horizontally and vertically in a “swathe”. Either way, original line scan data is converted into a format that a conventional CNN can consume. In embodiment, this is accomplished via a method whose parameters (the kernels at each stage) are learnt (trained), and which produces a rich encoding of the scene content to be further processed by the subsequent CNN stages.

For the processes and techniques described with respect to FIGS. 8-24, according to embodiments, a system having one or more detector arrays and/or a scanning mirror can be used. One example is provided in connection with FIGS. 26A-26C and FIG. 27. For instance, such systems can be used to scan or otherwise obtain samples of a scene (e.g., with RF radiation collection and processing). According to embodiments, radiation at a single frequency, or multiple frequencies, may be used.

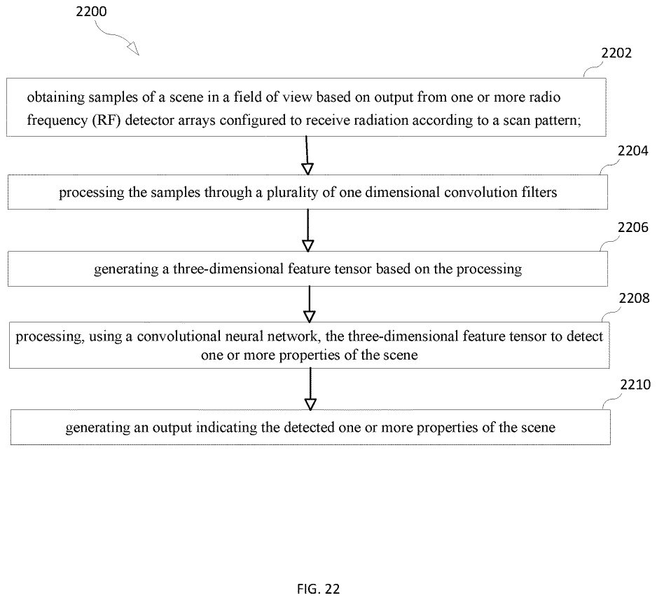

FIG. 22 illustrates a method 2200, according to some embodiments. In certain aspects, FIG. 22 illustrates scene processing method, which can be a computer-implemented method. Step 2202 of the method includes obtaining samples of a scene in a field of view based on output from one or more radio frequency (RF) detector arrays configured to receive radiation. In some embodiments, it is received according to a scan pattern. Step 2204 of the method includes processing the samples through a plurality of one-dimensional convolution filters. Step 2206 of the method includes generating a multi-dimensional (e.g., three-dimensional) feature tensor based on the processing. In some embodiments, one or more of steps 2204 and 2206 may be optional, or replaced with alternative processes to generate a multi-dimensional tensor. Step 2208 of the method includes processing, using a convolutional neural network, the feature tensor to detect one or more properties of the scene. Step 2210 of the method includes generating an output indicating the detected one or more properties of the scene.

In some embodiments, an image of the scene is generated. In some embodiments, the output can include an alarm. Where the scene includes a person wearing clothing, the detected one or more properties could be an item concealed under the clothing, or where the scene comprises a bag or container, the detected one or more properties could be an item located inside the bag or container. In embodiments, the generated output comprises a visual indication of the detected one or more properties in the generated image.

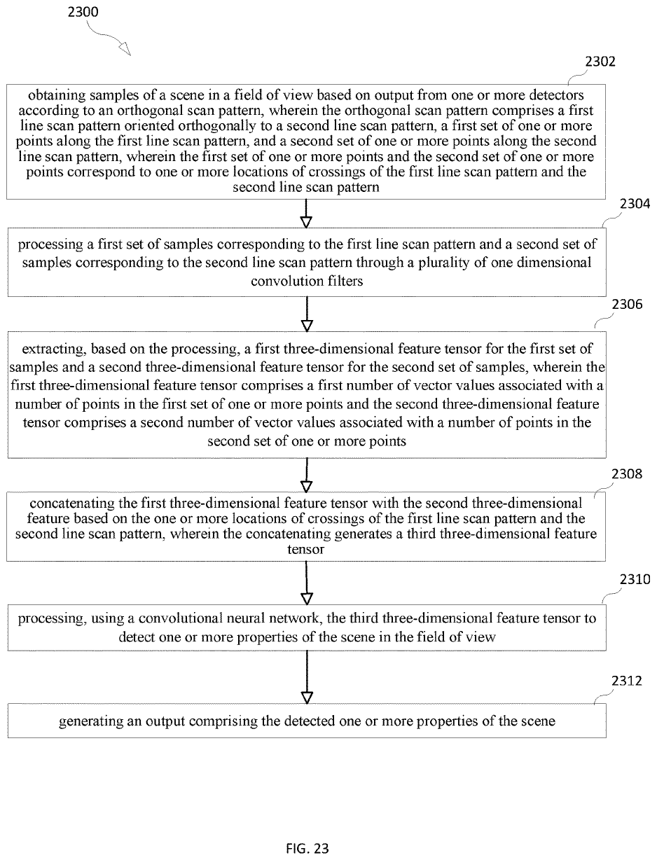

FIG. 23 illustrates a method 2300, according to some embodiments. In certain aspects, FIG. 23 illustrates a computer-implemented scene processing method. Step 2302 of the method includes obtaining samples of a scene in a field of view based on output from one or more detectors, for instance, according to an orthogonal scan pattern. In some embodiments, the orthogonal scan pattern can include (1) a first line scan pattern oriented orthogonally to a second line scan pattern, (2) a first set of one or more points along the first line scan pattern, and (3) a second set of one or more points along the second line scan pattern, wherein the first set of one or more points and the second set of one or more points correspond to one or more locations of crossings of the first line scan pattern and the second line scan pattern. The orthogonal scan pattern may correspond to the scan patterns described above, or other scan patterns. In some embodiments, the scan pattern of method 2300 may not be orthogonal, and in some embodiments, it may be near-orthogonal or use other complementary angles. Step 2304 of the method includes processing a first set of samples corresponding to the first line scan pattern and a second set of samples corresponding to the second line scan pattern. This could include, in some embodiments, processing through a plurality of one-dimensional convolution filters. Step 2306 of the method includes extracting, based on the processing, a first three-dimensional feature tensor (or other multi-dimensional feature tensor) for the first set of samples and a second three-dimensional feature tensor (or other multi-dimensional feature tensor) for the second set of samples. According to some embodiments, the first three-dimensional feature tensor comprises a first number of vector values associated with a number of points in the first set of one or more points and the second three-dimensional feature tensor comprises a second number of vector values associated with a number of points in the second set of one or more points. Step 2308 of the method includes concatenating the first three-dimensional feature tensor with the second three-dimensional feature. In embodiments, this is based on the one or more locations of crossings of the first line scan pattern and the second line scan pattern, wherein the concatenating generates a third three-dimensional feature tensor. Step 2310 of the method includes processing, using a convolutional neural network, the third three-dimensional feature tensor to detect one or more properties of the scene in the field of view. Step 2312, which may be optional in some embodiments, includes generating an output comprising the detected one or more properties of the scene.

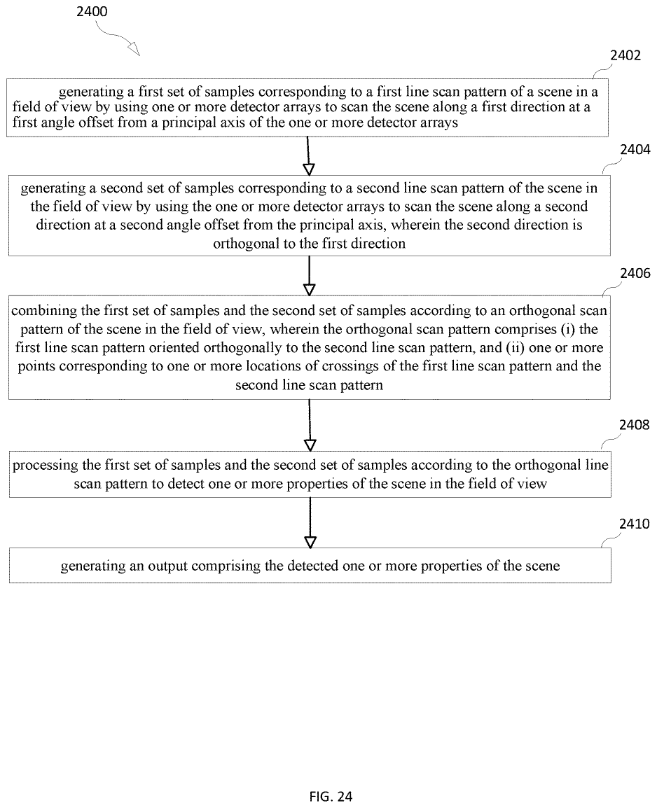

FIG. 24 illustrates a method 2400, according to some embodiments. In certain aspects, FIG. 24 illustrates a scene processing method. Step 2402 of the method includes generating a first set of samples corresponding to a first line scan pattern of a scene in a field of view by using one or more detector arrays to scan the scene along a first direction at a first angle offset from a principal axis of the one or more detector arrays. Step 2404 of the method includes generating a second set of samples corresponding to a second line scan pattern of the scene in the field of view by using the one or more detector arrays to scan the scene along a second direction at a second angle offset from the principal axis, wherein the second direction is orthogonal to the first direction. However, in other embodiments, the angles may not be orthogonal (e.g., non-orthogonal complementary patterns). Step 2406 of the method includes combining the first set of samples and the second set of samples according to an orthogonal scan pattern of the scene in the field of view. The orthogonal scan pattern may include: (i) the first line scan pattern oriented orthogonally to the second line scan pattern, and (ii) one or more points corresponding to one or more locations of crossings of the first line scan pattern and the second line scan pattern. Step 2408 of the method includes processing the first set of samples and the second set of samples according to the orthogonal line scan pattern to detect one or more properties of the scene in the field of view. Step 2410 of the method includes generating an output comprising the detected one or more properties of the scene. According to embodiments, one or more of the steps of 2400 may be omitted.

While convolution filters, including one-dimensional convolution filters are used in the examples of FIGS. 22-24, according to embodiments, other linear or non-linear operations may be used.

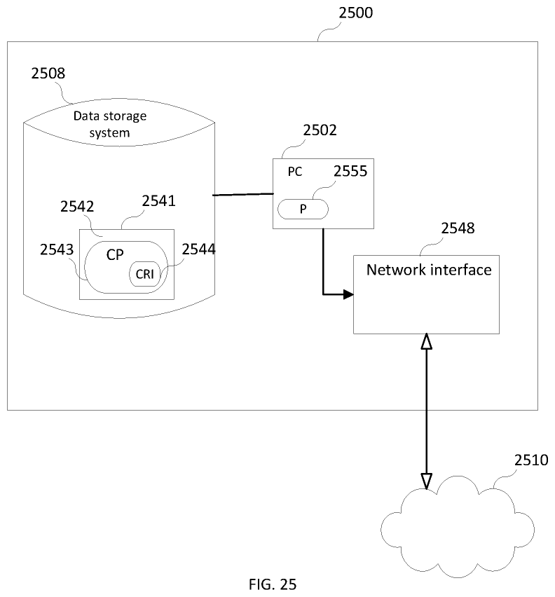

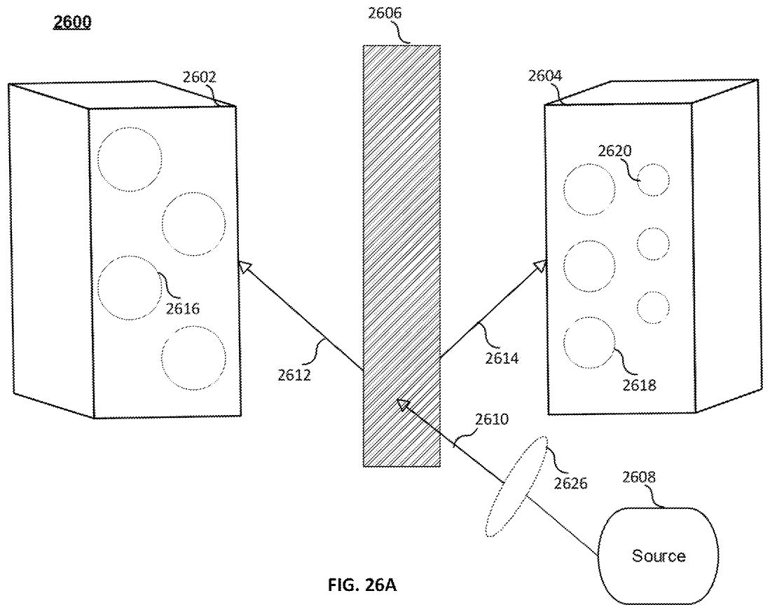

FIG. 25 is a block diagram of a computing system 2500, according to some embodiments. In some embodiments, computing system 2500 may comprise one or more of the CNNs described above. As shown in FIG. 25, the system may comprise: processing circuitry (PC) 2502, which may include one or more processors (P) 2555 (e.g., one or more general purpose microprocessors and/or one or more other processors, such as an application specific integrated circuit (ASIC), field-programmable gate arrays (FPGAs), and the like); communication circuitry 2548 for enabling the system to transmit data and receive data (e.g., transmit/receive data from network 2510); and a local storage unit (a.k.a., “data storage system”) 2508, which may include one or more non-volatile storage devices and/or one or more volatile storage devices. In embodiments where PC 2502 includes a programmable processor, a computer program product (CPP) 2541 may be provided. CPP 2541 includes a computer readable medium (CRM) 2542 storing a computer program (CP) 2543 comprising computer readable instructions (CRI) 2544. CRM 2542 may be a non-transitory computer readable medium, such as, magnetic media (e.g., a hard disk), optical media, memory devices (e.g., random access memory, flash memory), and the like. In some embodiments, the CRI 2544 of computer program 2543 is configured such that when executed by PC 2502, the CRI causes the system to perform steps described herein (e.g., steps described herein with reference to the flow charts). In other embodiments, the apparatus may be configured to perform steps described herein without the need for code. That is, for example, PC 2502 may consist merely of one or more ASICs. Hence, the features of the embodiments described herein may be implemented in hardware and/or software.

According to embodiments, scanning or otherwise obtaining scene information may comprise one or more of tilting one or more detector arrays; moving the one or more detector arrays along a first direction and/or a second direction; tilting a scanning mirror or reflector; moving a scanning mirror or reflector along the first direction and the second direction; and/or a combination thereof. That is, sensor arrays may be stationary or moveable. This can apply, according to embodiments, to any of the scanning, generating, or obtaining processes described with respect to FIGS. 3-24.

FIGS. 26A-26C show a detection system 2600 according to some embodiments. The system may be, for example, a high-frequency detection system such as a terahertz camera. FIG. 26B shows a top-view depiction of the system 2600 shown in FIG. 26A. This system can be used, for instance, with respect to the methods 2200, 2300, and 2400 described above. Likewise, the detection system 2600 can include a computing system 2500, as described with respect to FIG. 25.

Referring now to FIG. 26A, the system 2600 can include a first detector array 2602, a second detector array 2604, and a polarizing element 2606, such as a polarizing plate. As shown in FIG. 26A, the polarizing plate 2606 may be interposed between the detector arrays 2602, 2604 such that it passes and/or reflects radiation signals 2610 from a source 2608 to the detector arrays 2602, 2604. According to embodiments, a first radiation signal 2612 having a first polarization (e.g., a vertical polarization) is passed through the polarizing plate 2606 to the first detector array 2602, and a second radiation signal 2614 having a second polarization (e.g., a horizontal polarization) is reflected from the polarizing plate 2606 to the second detector array 2604. In the illustration of FIGS. 26A and 26B, both radiation signals are from source 2608, which can be, for example, one or more human beings emitting radiation 2610 towards the detection system 2600. Other sources may include, for instance, single objects of interest such as a vehicle or a structure, or entire scenes having multiple objects. Additionally, the radiation signal 2610 from source 2608 may actually originate from a secondary source (not shown), as in an active detection system. In this case, the signal 2610 may reflect from source 2608 towards system 2600. That is, system 2600 may be part of a passive or active detection implementation. According to embodiments, radiation at a single, or multiple, frequencies may be used.

According to some embodiments, the system 2600 does not require any optical elements interposed between the polarizing plate 2606 and either of the first or second detector arrays 2602,2604. While illustrated in FIGS. 26A and 26B with two detector array blocks 2602, 2604, few or additional array blocks may be used in system 2600, for instance, on top of or adjacent to arrays 2602, 2604. Moreover, while system 2600 is illustrated with detector array blocks 2602, 2604 spaced apart, in some embodiments, these arrays may be joined (e.g., as shown in FIG. 26C). For instance, in some embodiments, detector array block 2602 may be stacked on top of array block 2604, or placed directly adjacent to and connected with block 2604. In such cases, and in other embodiments, use of a polarizing plate 2606 may not be necessary. That is, radiation signals may be passed directly to the detector arrays from a scanning mirror 2026. Additionally, and in some embodiments of system 2600, one or more (n) other mirrors 2627a-c can be used to collect and pass the radiation to the detectors 2602, 2604 as illustrated in FIG. 26C. The other mirrors 2627 could be, for example, fixed. In some instances, they may be concave (e.g., 1- or 2-D parabolic).

Each of the detector arrays 2602, 2604 may comprise one or more input channels, such as feedhorns 2616, 2618, 2620. According to embodiments, the feedhorns capture radiation from source 2608 and pass the received signal into other portions of the system for subsequent processing. For instance, feedhorns 2616 can capture radiation 2612 passed through polarization plate and feedhorns 2618 and 2620 may capture radiation 2614 reflected from polarization plate 2606. Although depicted as circular waveguide in this example, other forms of waveguide (e.g., oval or rectangular waveguide) may be used as well.

According to some embodiments, the first detector array comprises a first plurality of feedhorns having a first width and a having spacing equal to or greater than the first width, and the second detector array comprises a second plurality of feedhorns having a second width and having a spacing equal to or greater than the second width. That is, the feedhorns may be substantially spaced apart. Additionally, first processing circuitry can be located between feedhorns of the first detector array, and second processing circuitry is located between feedhorns of the second detector array.

While depicted as 2×2 and 2×4 arrays, respectively, in FIG. 26A, the first detector array 2602 may have more than two feedhorns in each of a horizontal and vertical direction of the array, and similarly, the second detector array 2604 may have more than two feedhorns in each of a horizontal and vertical direction of the array. According to embodiments, the detector array blocks 2602, 2604 may be formed of multiple sub-blocks. And arrays/blocks can be stacked to form sensor groupings as needed for a given application.

As shown in FIG. 26B, and according to some embodiments, when the optional polarizing plate is used, the polarizing plate 2606 may be aligned at a 45 degree angle to each of the first and second detector arrays 2602, 2604. However, the plate 2606 may be aligned at different angles in certain arrangements, for instance, to account for the particular alignment or spacing of one or more of detectors 2602, 2604. That is, the polarizing plate may aligned at an angle greater than or less than 45 degrees. In some embodiments, the polarizing plate comprises a wire grid structure. In this example, the wire grid acts to pass vertically polarized radiation 26262 from the source 2608, while horizontally polarized radiation from the source 2608 is reflected. Although described with a wire grid and horizontal/vertical polarizations, in some instances, multi-layer dielectric polarizer plates and frequency selective surfaces may be used. Although illustrated as flat plate, the polarizing plate 2606 need not have flat surfaces, and could take the form of a lens or other curved structure. According to embodiments, a polarizing element (e.g., 2606) has a low insertion loss in both the pass-through mode and in the reflection mode. In certain aspects, the polarization element acts as a free-space polarization duplexer or orthomode transducer.

As shown in FIGS. 26A-26C, the system may further include a scanning mechanism 2626. The scanning mechanism 2626 may be based on one or more movable mirrors which reflect incoming radiation onto one or more detectors, such as arrays 2602,2604. In some embodiments, additional mirrors 2627a-c may also be included. An image may be recovered by scanning (e.g., moving) the mirror(s) so that the detector(s) effectively follow a scanning raster relative to the field of view. The mirror(s) might move so as to produce a scanning raster comprising spaced scan lines, and to produce the scanning raster, the mirror could move differently in different directions. For example, the mirror might reciprocate about a first axis to create scan lines coupled with a stepped rotation about a second axis to set the scan line spacing. According to embodiments, the mirror(s) 2626 can be used to produce the scan patterns discussed above, including with respect to FIGS. 6-13 and 15-24. Moreover, in embodiments, methods 2200, 2300, and 2400 can include steps for moving a scanning mirror, such as mirror(s) 2626 (e.g., to scan a scene or otherwise obtain the radiation signals or samples).

Structurally, the scanning mechanism could, in some embodiments, comprise: (i) a mirror structure mounted for rotation about a first axis; (ii) an intermediate support structure for carrying the mirror structure, the intermediate support structure being mounted for rotation about a second axis; (iii) a base support structure for carrying the intermediate support structure; (iv) a mirror drive mechanism mounted in part on the intermediate support structure and in part on the mirror structure, for driving the mirror structure to rotate about the first axis; and/or (v) an intermediate drive mechanism mounted in part on the base support structure and in part on the intermediate support structure for driving the intermediate support structure to rotate about the second axis, whereby the mirror structure can be driven to rotate about either one or both of the first and second axes. The mirror itself may be a thin, metal (e.g., aluminum) mirror comprising a thin (e.g., 0.5 mm) sheet with or without reinforcing ribs.

An adaptive scanning mirror may be used to scan a field of regard in successive detections of the field of view. “Field of view” in this context is intended to refer to the area of a scene being viewed, or sensed, either by the detection system or by the one or more of the detector elements. That is, it is intended to refer to the area of a scene that is currently being imaged or sensed by the detectors due to, for instance, movement of the scanning mirror(s). For example, in imaging to give successive frames in relation to a scene, each frame will show the field of view. “Field of regard” in this context is intended to refer to the largest area of the scene that could he accessible to the system/detectors by steering the scanning mirror(s) without moving the detectors. With respect to the detection system 2600, the field of regard refers to the angular range within which the detection system is capable of detecting objects of interest. According to embodiments, the detector outputs are converted to graphical data to support screen-based representations of the detected fields of view, and may, for example, be combined to form a composite image of the field of regard. Additionally, fields of view in different bands may be combined to form a composite image of a field of view.

In some embodiments, one or more of the detectors may be moveable or tiltable in order to perform a scanning operation. This can include, for instance, any of the operations described with respect to FIGS. 22-24.

Referring now to FIG. 27, a schematic depiction of a detection system 2700 according to some embodiments is provided. Radiation can be received at inputs 2702, 2704, and 2706, which may be feedhorns of block 2708, 2710, and 2712, respectively. In some embodiments, block 2708 may correspond to detector array 2602, and blocks 2710 and 2712 may each form a part of detector array 2604. The radiation signals received at inputs 2702, 2704, 2706 are each passed to a mixer element, depicted as elements 2714a, 2714b, and 2714c. In some embodiments, one or more of the received signals may be rotated before processing by a mixer, for instance, by optional polarization rotation element 2716. The processed signals from the mixer, such as one or more intermediate frequency (IF) signals, are passed to the output (2718a, 2718b, 2718c) of each block for subsequent, additional processing by a low noise amplifier (LNA) (2720a, 2720b, 2720c), power detector (2721a, 2721b, 2721c), and analog to digital converter (ADC) (2722a, 2722b, 2722c). Additional processing may include filtering. The digital signals may then be passed to image generator 2724 to form an image based on the detected radiation, such a composite image of an object or scene using the radiation received at 2702, 2704, and 2706. The image processing 2724 may be coupled to, or part of, a viewing system 2736, such as a computer or monitor. In some embodiments, the IF signals are outputted using coaxial cable within each block.

Although this system is depicted with three mixer elements or inputs, it could be implemented with more or less. For instance, the system 2700 could be extended to include a fourth set of input feedhorns, each with a corresponding set of mixers and processing circuitry. While the system of FIGS. 26 and 27 may be configured to operate at multiple frequencies, in embodiments, a single operational frequency may be used.

In some embodiments, the local oscillator (LO) signal is provided to the mixers of system 2700 using fewer LO sources than mixers. For instance, in the example illustrated in FIG. 27, a single LO source 2726 provides an LO signal to each of mixers 2714a-c. According to embodiments, this is accomplished using one or more power dividers 2728a, 2728b, and in some instances, one or more frequency multipliers 2730a-c, such as doublers or triplers. For example, an original LO signal from source 2726 could be provided to divider 2728a, which in turn provides signal to divider 2728b and an optional multiplier 2730a. The multiplier 2730 may be used to provide mixer 2714a with an LO signal at a higher frequency than is provided by source 2726. Similarly, divider 2728b may provide signal to optional multipliers 2730b and 2730c for mixers 2714b and 2714c. In this respect, each of blocks 2708, 2710, and 2712 can be configured for operation at different frequencies/wavelengths. Such configuration could include, for instance, the mixer design as well as the shape and dimensions of the input feedhorns (e.g., 2616, 2618, and 2620). Accordingly, different wavelength radiation signals may be detected, processed, and used by the processing circuitry 2724 to form a composite image using data at multiple wavelengths. One or more amplifiers, such as amplifier 2732 may be used to boost a signal between a source, divider, multiplier, and/or mixer. Other amplifiers are not illustrated in the example of FIG. 27.

The feedhorn size should be selected to provide the most optimum coupling to the chosen optics, and the spacing should be selected to provide the optimum coverage depending on the application.

In certain aspects, components are optimized to minimize the amount of LO power reflected from the RF coupling circuit over as wide range of circuit operating conditions as possible. This limits reflected LO signal propagating back into one or more LO power splitters, thus limiting interference between channels. To further reduce reflection issues, a 90 degree 3 dB hybrid power splitter such as a Magic-T or a 3 dB hybrid branch guide coupler could be implemented.

According to some embodiments, one or more of dividers 2728a and 2728b is a non-equal divider. According to some embodiments, multipliers 2730a and 2730b are doublers while multiplier 2730c is a tripler. In some embodiments one or more of the multipliers is not needed. For example, multiplier 2730a may be omitted in some embodiments.

According to some embodiments, a common local oscillator source 2726 is provided, multiplied in frequency using different order frequency multipliers (e.g., doublers and triplers), and subharmonic mixers are implemented. For example, mixers 2714a-c may be operating in bands centered on the frequencies 125 GHZ, 250 GHz and 375 GHz, respectively, which can use local oscillator frequencies of 62.5 GHZ, 125 GHz and 187.5 GHz. In this example, the base local oscillator source 2726 may be a Gunn oscillator providing approximately 100 mW operating at 62.5 GHz. According to embodiments, other frequencies can be used. This is split into two equal signals using a splitter, such as divider 2728a. This may be an equal power splitter, such as a standard magic-tee, or a non-equal splitter. One half of the splitter output pumps the 125 GHz array (block 2708 in this example), and the second half is input into a power amplifier (e.g., amplifier 2732 in this example) to give a signal of approximately 400 mW that is then used to pump frequency multipliers 2730b and 2730c. Given the use of a subharmonic mixer at the example frequencies, the multiplier 2730a is not required in this instance. In some embodiments, the system is optimized by using a configurable, non-equal power divider to provide the optimum power to the 125 GHz array and power amplifier. Each frequency mixer array requires similar local oscillator power, 30-40 mW in this example. However the typical efficiency of a doubler is 40% whereas a tripler is 15%. This means that use of an equal power splitter such as a magic-tee can result in too much power (80 mW) being generated for the 250 GHz array (e.g., block 2710 in this example) and marginal power for the 375 GHz array (e.g., block 2712 in this example). Traditional power splitters such as magic-tees rely on the input power being split equally in half, however, if such an approach is used for this embodiment, it results in too much power being supplied to the 125 GHz doubler (e.g., multiplier 2730b) and not enough power being supplied to the 187.5 GHz tripler (e.g., multiplier 2730c). Therefore in order to supply sufficient power to the tripler, which is typically less efficient than a doubler, the power amplifier would need to be over specified and the power to the doubler would be unnecessarily attenuated (otherwise it can be damaged). This is not only costly and wasteful of LO signal, but can be difficult to achieve with existing technologies and results in higher electrical bias power and heat removal requirements. Thus, and according to embodiments, a configurable power divider is used that can split the local oscillator pump power arbitrarily into two or more pathways, thereby dividing the power for each local oscillator arm's multipliers according to their respective power requirements. According to embodiments, dividers 2728a and/or 2728b are configurable. Thus, a system can be provided in which the overall system LO power requirement (and thereby cost) is minimized by matching the power split to each frequency arm so that the power delivered matches the peak efficiency input power requirement for each respective multiplier.

According to some embodiments, one or more blocks configured to receive and process radiation at a fourth frequency may be provided. For instance, one or more blocks may be configured at 500 GHz, or another frequency. The mixer for such a block could similarly operate using the same LO source, for instance, with an additional divider and or doubler in one or more of the LO paths shown in FIG. 27. In some embodiments, the block may be a sub-block or arrays 2602, 2604.

According to some embodiments, the LO source 2726 may have multiple outputs at one or more frequencies, and initial divider 2728a and/or multiplier 2730a may not be required. In some embodiments, one or more of divider 2728a and multiplier 2730a are integrated into the local oscillator source 2726, such that source 2726 provides multiple frequency signals at configurable powers. Although two outputs are used by way of example, this implementation could be extended through the use of additional non-equal power splitters and/or multipliers.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

1. A scene processing method, the method comprising:
obtaining samples of a scene in a field of view based on output from one or more radio frequency (RF) detector arrays configured to receive radiation;
processing, using a convolutional neural network, a multi-dimensional feature tensor based on the scene to detect one or more properties of the scene; and
generating an output indicating the detected one or more properties of the scene.

2. The method of claim 1, wherein the feature tensor is a three-dimensional tensor.

3. The method of claim 1, further comprising:
processing the samples through a plurality of one-dimensional convolution filters.

4. The method of claim 1, further comprising:
generating the multi-dimensional feature tensor.

5. The method of claim 4, wherein the multi-dimensional feature tensor is generated based on processing the samples.

6. The method of claim 1, wherein the radiation is received according to a scan pattern.

7. The method of claim 3, further comprising:
extracting, based on the processing the samples through the plurality of one dimensional convolution filters, a first three-dimensional feature tensor and a second three-dimensional feature tensor.

8. The method of claim 7, wherein the generating further comprises:
concatenating the first three-dimensional feature tensor with the second three-dimensional feature tensor.

9. The method of claim 1, wherein the processing, using the convolutional neural network, is performed without generating an image of the scene.

10. The method of claim 1, wherein the output comprises an alarm.

11. The method of claim 1, further comprising:
generating an image of the scene.

12. The method of claim 11, wherein the generated output comprises a visual indication of the detected one or more properties in the generated image.

13. The method of any of claim 6, wherein the scan pattern is an orthogonal scan pattern comprising:
a first line scan pattern oriented orthogonally to a second line scan pattern,
a first set of one or more points along the first line scan pattern, and
a second set of one or more points along the second line scan pattern, wherein the first set of one or more points and the second set of one or more points correspond to one or more locations of crossings of the first line scan pattern and the second line scan pattern.

14. The method of claim 1, wherein the one or more RF detector arrays are configured to receive radiation having a frequency of 125 GHZ, 250 GHz, or 375 GHz.

15. The method of claim 1, wherein the scene comprises a person wearing clothing and the detected one or more properties is an item concealed under the clothing, or wherein the scene comprises a bag or container and the detected one or more properties is an item located inside the bag or container.

16. The method of claim 1, wherein the obtaining further comprises:
moving a scanning mechanism according to a scan pattern.

17. A scene processing system comprising:
a processor; and
a non-transitory memory coupled to the processor, wherein the processor is configured to perform a method comprising:
obtaining samples of a scene in a field of view based on output from one or more radio frequency (RF) detector arrays configured to receive radiation;
processing, using a convolutional neural network, a multi-dimensional feature tensor based on the scene to detect one or more properties of the scene; and
generating an output indicating the detected one or more properties of the scene.

18. (canceled)

19. A system configured to:
obtain samples of a scene in a field of view based on output from one or more radio frequency (RF) detector arrays configured to receive radiation;
process, using a convolutional neural network, a multi-dimensional feature tensor based on the scene to detect one or more properties of the scene; and
generate an output indicating the detected one or more properties of the scene.

20. (canceled)

21. The system of claim 19, comprising one or more of:
(i) a first detector array;
(ii) a second detector array; or
(iii) a scanning mechanism.

22.-45. (canceled)
